(19) United States
(12) Patent Application Publication
(10) Pub. No.: US 2023/0405739 A1
(43) Pub. Date: Dec. 21, 2023

(54) ANGLE ELEMENT FOR A WELDING AND CLAMPING TABLE SYSTEM AND MODULAR SYSTEM FOR THE PRODUCTION OF VARIOUS VARIANTS OF AN ANGLE ELEMENT

(71) Applicant: Bernd Siegmund GmbH, 86507 Oberottmarshausen (DE)

(72) Inventor: Bernd Siegmund, Grossaitingen (DE)

(73) Assignee: Bernd Siegmund GmbH, 86507 Oberottmarshausen (DE)

(21) Appl. No.: 18/029,001

(22) PCT Filed: Sep. 15, 2021
(86) PCT No.: PCT/EP2021/025347

§ 371 Date: Mar. 28, 2023

(30) Foreign Application Priority Data
Sep. 29, 2020 (DE) 10 2020 005 959.7

(51) Int. Cl. B23K 37/04; B25B 5/00

(52) U.S. Cl. CPC B23K 37/0452; B23K 37/0461; B25B 5/006

(57) ABSTRACT

An angle element for a welding and clamping table system includes an L-shaped profile, a base plate releasably fastened at one end of the L-shaped profile and provided with a system borehole of the welding and clamping table system, and a member releasably fastened at another end of the L-shaped profile and selected from the group consisting of a further such base plate and a clamping plate which is provided with several threaded boreholes to accommodate various hole patterns of quick-change clamps.

The invention relates to an angle element for a welding and clamping table system and to a modular system for the production of various variants of an angle element.

Angle elements find application in connection with welding and clamping table systems, with which objects can be clamped and welded or processed in some other way. In addition, however, there are also a great number of other possible uses for welding and clamping table systems, for example for measuring devices or the like. Welding tables are known from EP 0 541 904 A1 or DE 91 09 540 U1.

Welding tables have a great number of mostly round system boreholes in their surface and possibly also in the lateral walls of the table top, which system boreholes are arranged in a uniform grid and can be configured with different diameters. In addition, the welding tables have a wide range of accessories that enable objects to be clamped. Thus, essentially angle-shaped supports are provided, which also have round system boreholes or oblong openings. These supports can be connected to one another or to the table by clamping means, such as clamping bolts, which can be comprised of a threaded screw with associated nut. In addition, clamping bolts find also application, which are inserted into the system boreholes of the table from one side and are supported within the system boreholes or on the underside of the table top. Besides the afore-mentioned publications, such clamping bolts are also known from DE 19917 209 A1 and DE 202 19 317 U1.

In addition, in connection with welding tables, screw clamps are used as clamping means, which are also used to brace objects. Such screw clamps can be found in addition to the already afore-mentioned publications in U.S. Pat. No. 4,867,427, DE 100 11 490 A1, DE 200 23 552 U1, DE 202 04 107 U1, DE 202 12 731 U1, DE 20219 317 U1, DE 10 2009 022 013 A1 or in the form of quick-change clamps in DE 90 15 218 U1. Moreover, various configurations of quick-change clamps are known, for example vertical clamps, horizontal clamps or push-rod clamps that have base plates with a hole pattern for attachment to a plate.

Various stops with round and/or oblong openings and prisms are known as further accessories.

The invention is based on the problem to provide an angle element for a welding and clamping table system and a modular system for the production of various variants of an angle element, which are useable particularly flexibly.

This problem is solved with the features of the independent claims. Advantageous refinements of the invention are set forth in the dependent claims.

The angle element according to the invention for a welding and clamping table system includes an L-shaped profile, at one end of which a base plate and at the other end of which either a base plate or a clamping plate are releasably fastened, with the base plate being provided with at least one system borehole of the welding and clamping table system and with the clamping plate being provided with several threaded boreholes to capture different hole pattems of quick-change clamps. The angle element can be connected to a welding table via the system borehole of the base plate, for example via a clamping bolt, while maintaining rotational mobility. In the event there is also a base plate with a system borehole at the other end of the angle element, then other accessories from the welding and clamping table system can be used there, for example screw clamps with a round base or angle brackets can be fastened using an additional clamping bolt. In the event there is a clamping plate at the other end of the angle element, then a quick-change clamp can be fastened there, for example bolted.

A particular flexibility of possible applications results from the modular system according to the invention for the production of various variants of an angle element. Provision is made in the modular system for
a plurality of various L-shaped profiles in different stability characteristics,
a plurality of various base plates with different system boreholes for different welding and clamping table systems and/or with different dimensions corresponding to the stability characteristics of the L-shaped profiles, as well as
a plurality of various clamping plates with different dimensions according to the stability characteristics of the L-shaped profiles.

The different stability characteristics of the L-shaped profiles can include, for example, a light configuration, a standard configuration, and a heavy configuration, which differ in the dimensions of the length and thickness of the legs.

The various variants of the base plates can be provided with different system boreholes for different welding and clamping table systems on one hand and/or have different dimensions according to the stability characteristics of the L-shaped profiles on the other hand. It would also be possible, for example, to attach on both ends base plates with system boreholes from different welding and clamping table systems to thereby attain a further increase in flexibility when using accessories.

The various variants of the clamping plates can have different dimensions according to the stability characteristics of the L-shaped profiles.

The various L-shaped profiles can be provided in standardized length and can be shortened individually. This is particularly advantageous when the L-shaped profiles are produced as extruded aluminum profiles, which are sold by the meter and can be cut to length individually by the customer. For technical reasons, it may hereby be necessary to specify maximum and minimum lengths.

When the outer sides of the legs of the various L-shaped profiles are provided with T-slots and/or threaded boreholes, templates for inserting and positioning workpieces can be screwed into them. The workpieces are then fixed using quick-change clamps in various designs, which are mounted on the clamping plate or laterally in the T-slots or threaded boreholes. As an alternative, it is also possible to fix the workpieces with clamping elements from the accessories of a welding and clamping table system when fastening a second base plate to the L-shaped profile.

A further increase in variability is achieved when the various base plates and/or the various clamping plates have mounting boreholes which coincide with corresponding boreholes in the face ends of one or more of the various L-shaped profiles and can be fastened to the L-shaped profiles using self-tapping screws. With mounting boreholes for several of the various L-shaped profiles, it is possible for a base plate to be fastened to L-shaped profiles with different stability characteristics.

The afore-mentioned rotational mobility of the angle element about the system borehole in the base plate can be established via a second clamping bolt when the various base plates have at least one circular arc-shaped recess for different welding and clamping table systems.

In the drawing, the invention is explained in more detail with reference to exemplary embodiments. It is shown in:

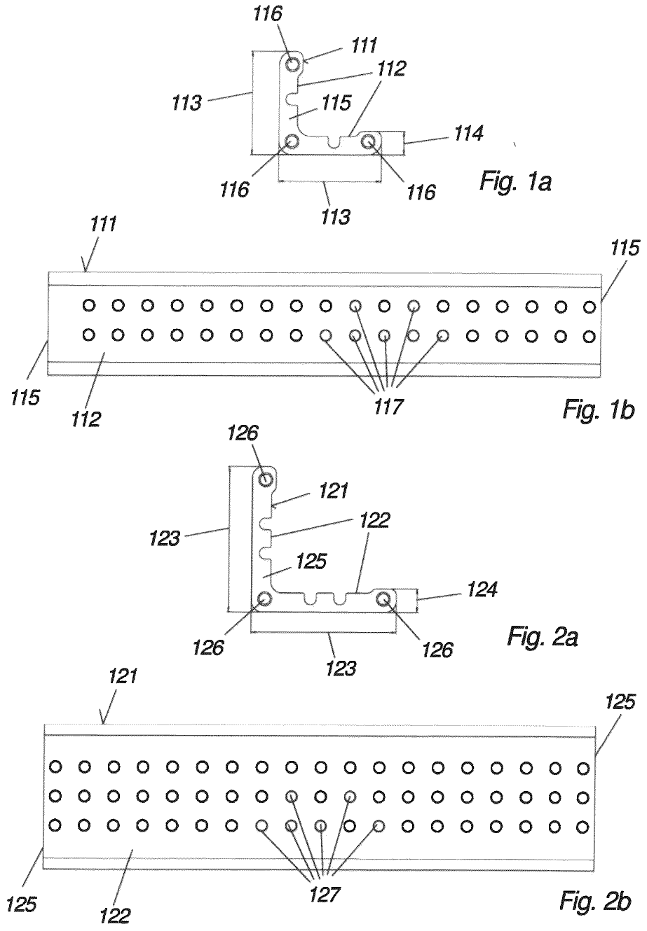

FIGS. 1a, 1b, 2a, 2b, 3a, 3b, 4a, 4b, 5a, 5b, 6a, 6b various variants of L-shaped profiles,

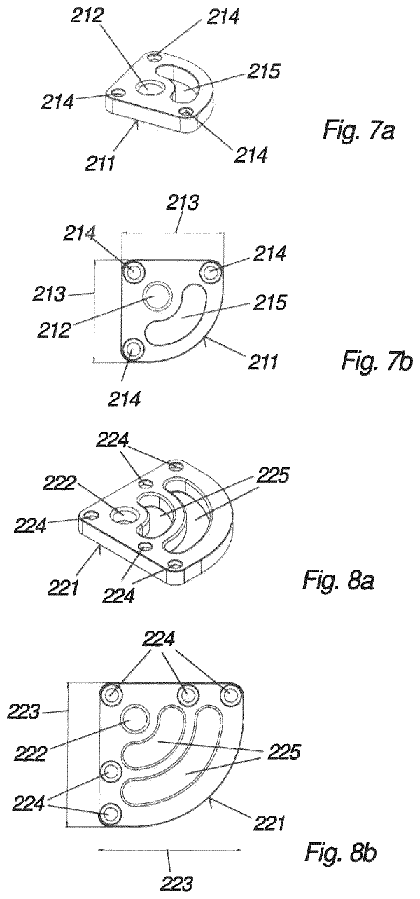

FIGS. 7a, 7b, 8a, 8b, 9a, 9b, 10a, 10b, 11a, 11b, 12a, 12b, 13a, 13b various variants of base plates,

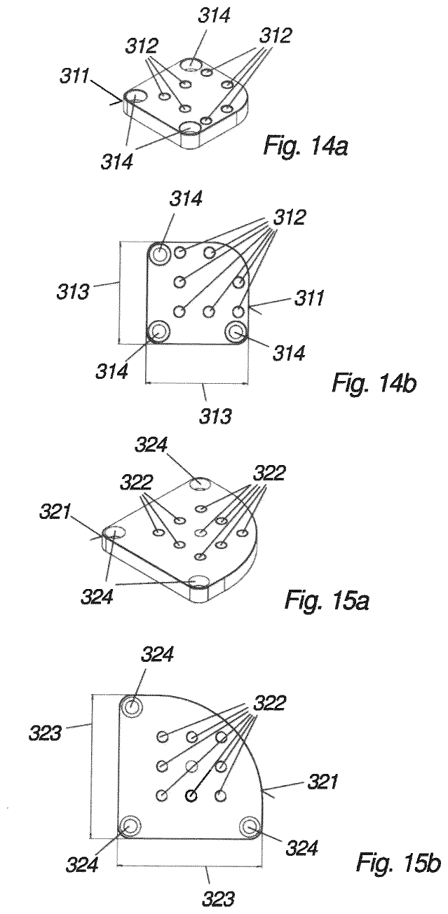

FIGS. 14a, 14b, 15a, 15b, 16a, 16b various variants of clamping plates,

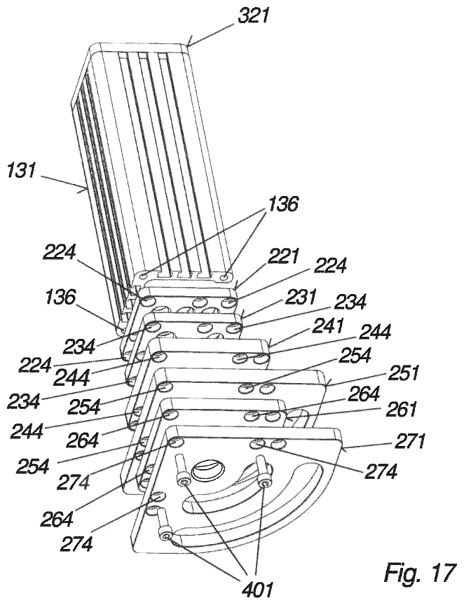

FIGS. 17, 18, 19 various possible combinations of L-shaped profiles and base plates,

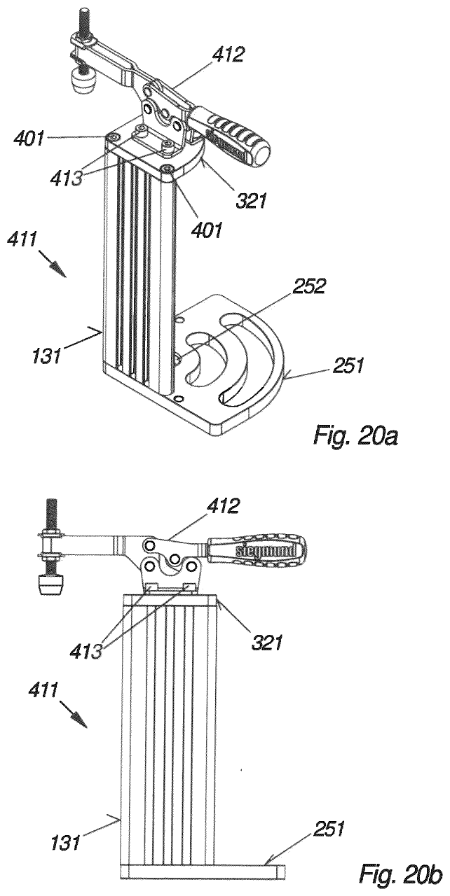

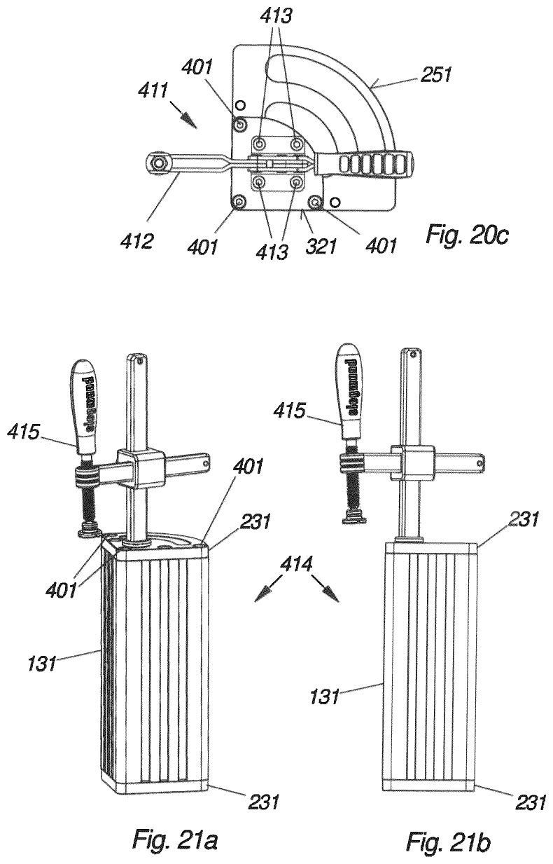

FIGS. 20a, 20b, 20c an exemplary embodiment of an angle element with a quick-change clamp, and

FIGS. 21a, 21b an embodiment of an angle element with a screw clamp.

FIGS. 1a, 1b, show an L-shaped profile 111 in a light configuration. The legs 112 have, for example, a length 113 of 70 mm and a thickness 114 of 16 mm. Boreholes 116 are provided in the face ends 115. The outer sides of the legs 112 are provided with threaded boreholes 117.

An L-shaped profile 121 is depicted in a standard design in FIGS. 2a, 2b. The legs 122 have, for example, a length 123 of 99 mm and a thickness 124 of 16 mm. Borehole 126 are provided in the face ends 125. The outer sides of the legs 122 are provided with threaded boreholes 127.

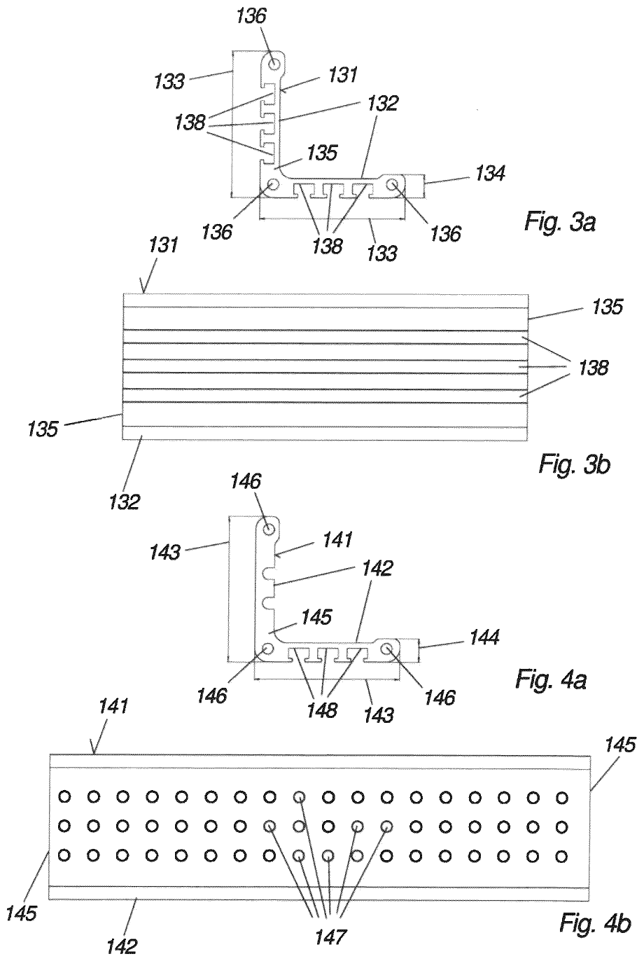

FIGS. 3a, 3b depict another L-shaped profile 131 in a standard design. The legs 132 have, for example, a length 133 of 99 mm and a thickness 134 of 16 mm. Boreholes 136 are provided in the face ends 135. The outer sides of the legs 132 are provided with T-slots 138.

FIGS. 4a, 4b depict another L-shaped profile 141 in a standard configuration. The legs 142 have, for example, a length 143 of 99 mm and a thickness 144 of 16 mm. Boreholes 146 are provided in the face ends 145. The outer side of one leg 142 is provided with threaded boreholes 147 and the outer side of the other leg 142 is provided with T-slots 148.

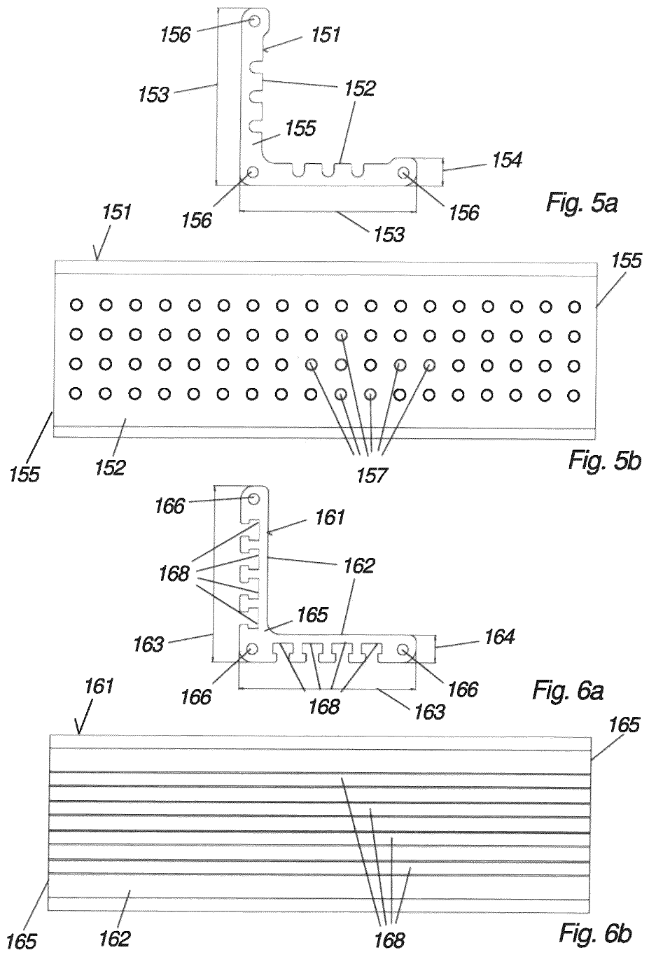

FIGS. 5a, 5b depict an L-shaped profile 151 in a heavy configuration. The legs 152 have, for example, a length 153 of 120 mm and a thickness 154 of 19 mm. Boreholes 156 are provided in the face ends 155. The outer sides of the legs 152 are provided with threaded boreholes 157.

FIGS. 6a, 6b depict another L-shaped profile 161 in a heavy configuration. The legs 162 have, for example, a length 163 of 120 mm and a thickness 164 of 19 mm. Boreholes 166 are provided in the face ends 165. The outer sides of the legs 162 are provided with T-slots 168.

In the case of extruded aluminum profiles as L-shaped profile 111, 121, 131, 141, 151, 161, the boreholes 116, 126, 136, 146, 156, 166 extend through the entire L-shaped profile 111, 121, 131, 141, 151, 161. This makes it possible to shorten the L-shaped profile 111, 121, 131, 141, 151, 161 to a suitable length and still use the boreholes 116, 126, 136, 146,156, 166.

FIGS. 7a, 7b depict a base plate 211 with a system borehole 212 with a diameter of, for example, 16 mm. The dimensions 213 of the base plate 211 are 69.4 mm, for example. The base plate 211 has mounting boreholes 214 which coincide with the corresponding boreholes 116 in the face ends 115 of the L-shaped profile 111. Using self-tapping screws enables the base plate 211 to be fastened to the L-shaped profile 111. Furthermore, the base plate 211 is provided with a circular arc-shaped recess 215 with, for example, a radius of 25 mm about the system borehole 212.

FIGS. 8a, 8b depict another base plate 221 with a system borehole 222 with a diameter of 16 mm, for example. The dimensions 223 of the base plate 221 are 98.4 mm, for example. The base plate 221 has mounting boreholes 224 which coincide with the corresponding boreholes 116 or 126, 136, 146 in the face ends 115 or 125, 135, 145 of the L-shaped profile 111 or 121, 131, 141. Using self-tapping screws, the base plate 221 can thus be fastened to the L-shaped profile 111 or 121, 131, 141. Furthermore, the base plate 221 is provided with two circular arc-shaped recesses 225 with a radius of, for example, 25 mm and 50 mm about the system borehole 222.

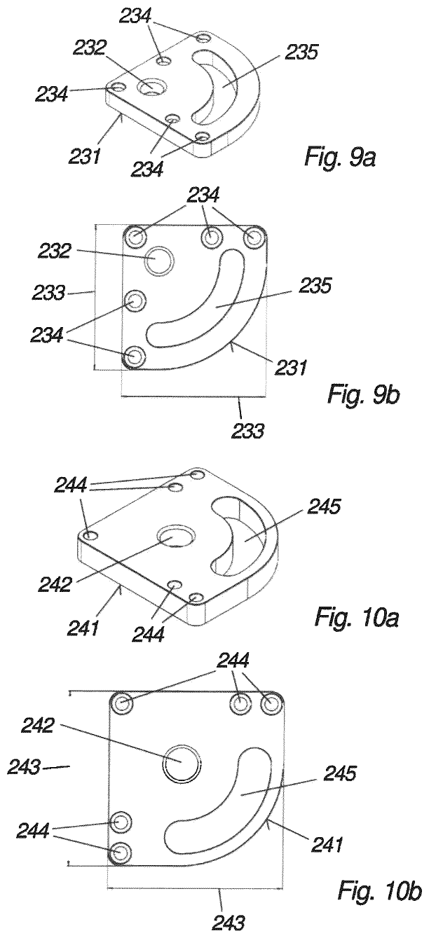

FIGS. 9a, 9b depict a further base plate 231 with a system borehole 232 with a diameter of 16 mm, for example. The dimensions 233 of the base plate 231 are 98.4 mm, for example. The base plate 231 has mounting boreholes 234 which coincide with the corresponding boreholes 116 or 126, 136, 146 in the face ends 115 or 125, 135, 145 of the L-shaped profile 111 or 121, 131, 141. Using self-tapping screws, the base plate 231 can be fastened to the L-shaped profile 111 or 121, 131, 141. Furthermore, the base plate 231 is provided with a circular arc-shaped recess 235 with a radius of, for example, 50 mm about the system borehole 232.

FIGS. 10a, 10b depict a base plate 241 with a system borehole 242 with a diameter of 22 mm, for example. The dimensions 243 of the base plate 241 are 119.4 mm, for example. The base plate 241 has mounting boreholes 244 which coincide with the corresponding boreholes 126, 136, 146 or 156, 166 in the face ends 125, 135, 145 or 155, 165 of the L-shaped profile 121, 131, 141 or 151, 161. Using self-tapping screws, the base plate 241 can thus be fastened to the L-shaped profile 121, 131, 141 or 151, 161. Furthermore, the base plate 241 is provided with a circular arc-shaped recess 245 with a radius of, for example, 50 mm about the system borehole 242.

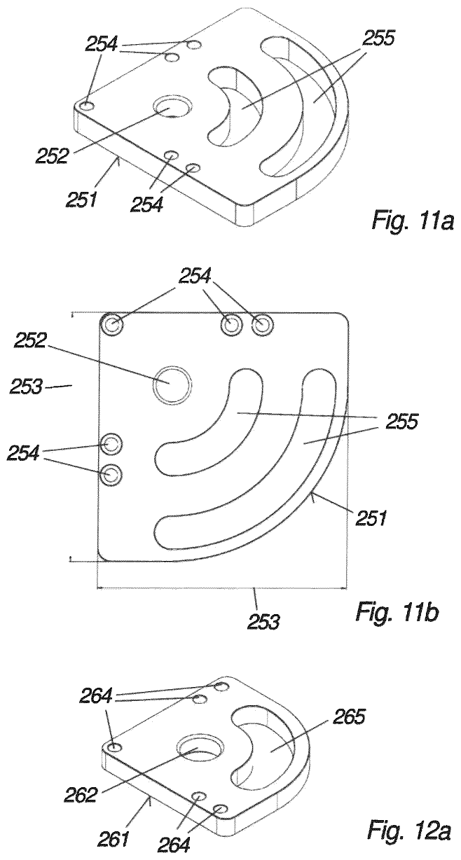

FIGS. 11a, 11b depict another base plate 251 with a system borehole 252 with a diameter of 22 mm, for example. The dimensions 253 of the base plate 251 are 169.4 mm, for example. The base plate 251 has mounting boreholes 254 which coincide with the corresponding boreholes 126, 136, 146 or 156, 166 in the face ends 125, 135, 145 or 155, 165 of the L-shaped profile 121, 131, 141 or 151, 161. Using self-tapping screws, the base plate 251 can thus be fastened to the L-shaped profile 121, 131, 141 or 151, 161. Furthermore, the base plate 251 is provided with two circular arc-shaped recesses 255 with a radius of, for example, 50 mm and 100 mm about the system borehole 252.

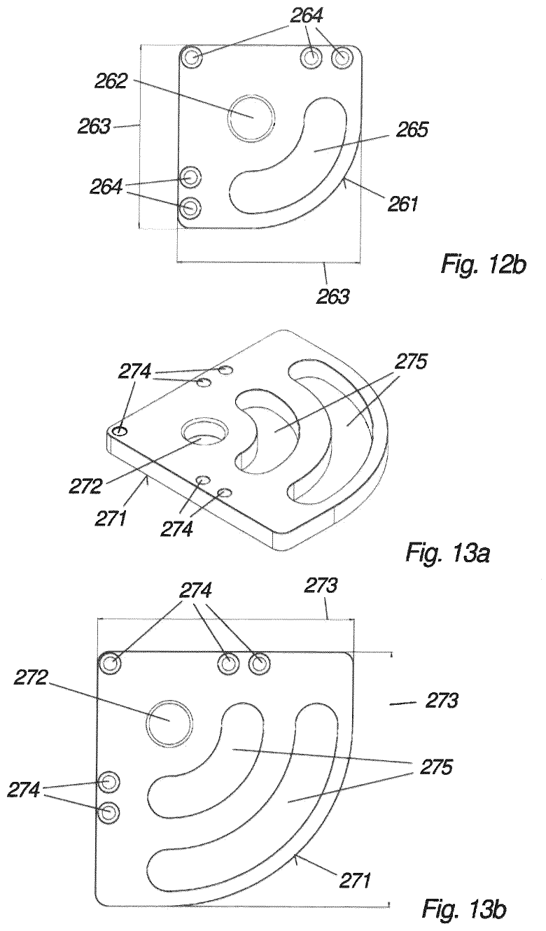

FIGS. 12a, 12b depict a base plate 261 with a system borehole 262 with a diameter of 28 mm, for example. The dimensions 263 of the base plate 261 are 124.4 mm, for example. The base plate 261 has mounting boreholes 264 which coincide with the corresponding boreholes 126, 136, 146 or 156, 166 in the face ends 125, 135, 145 or 155, 165 of the L-shaped profile 121, 131, 141 or 151, 161. Using self-tapping screws, the base plate 261 can thus be fastened to the L-shaped profile 121, 131, 141 or 151, 161. Furthermore, the base plate 261 is provided with a circular arc-shaped recess 265 with a radius of, for example, 50 mm about the system borehole 262.

FIGS. 13a, 13b depict another base plate 271 with a system borehole 272 with a diameter of 28 mm, for example. The dimensions 273 of the base plate 271 are 174.4 mm, for example. The base plate 271 has mounting boreholes 274 which coincide with the corresponding boreholes 126, 136, 146 or 156, 166 in the face ends 125, 135, 145 or 155, 165 of the L-shaped profile 121, 131, 141 or 151, 161. Using self-tapping screws, the base plate 271 can thus be fastened to the L-shaped profile 121, 131, 141 or 151, 161. Furthermore, the base plate 271 is provided with two circular arc-shaped recesses 275 with a radius of, for example, 50 mm and 100 mm about the system borehole 272.

With the corresponding clamping bolts of the respective welding and damping table system, the base plates 211, 221, 231, 241, 251, 261, 271 can be fastened on a welding table, while maintaining a rotational mobility.

FIGS. 14a, 14b depict a clamping plate 311 with threaded boreholes 312. The threaded boreholes 312 are arranged such as to accommodate various hole patterns of quick-change clamps. The dimensions 313 of the damping plate 311 are 69.4 mm, for example. The clamping plate 311 has mounting boreholes 314 which coincide with the corresponding boreholes 116 in the end faces 115 of the L-shaped profile 111. Using self-tapping screws, the clamping plate 311 can thus be fastened to the L-shaped profile 111.

FIGS. 15a, 15b depict another clamping plate 321 with threaded boreholes 322. The threaded boreholes 322 are arranged to accommodate various quick release hole patterns. The dimensions 323 of the clamping plate 321 are 98.4 mm, for example. The damping plate 321 has mounting boreholes 324 which coincide with the corresponding boreholes 126, 136, 146 in the face ends 125, 135, 145 of the L-shaped profile 121, 131, 141. Using self-tapping screws, the clamping plate 321 can thus be fastened to the L-shaped profile 121, 131, 141.

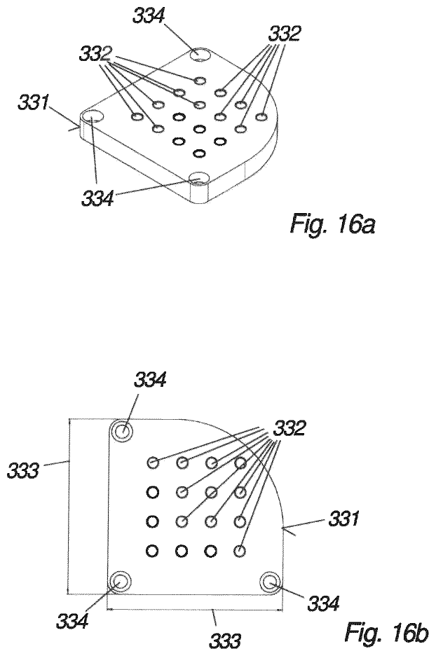

FIGS. 16a, 16b depict a further clamping plate 331 with threaded boreholes 332. The threaded boreholes 332 are arranged such as to accommodate various hole patterns of quick-change clamps. The dimensions 333 of the damping plate 331 are 119.4 mm, for example. The clamping plate 331 has mounting boreholes 334 which coincide with the corresponding boreholes 156, 166 in the face ends 155, 165 of the L-shaped profile 151, 161. Using self-tapping screws, the damping plate 331 can thus be fastened to the L-shaped profile 151, 161.

The possible combinations of the various variants of the L-shaped profiles 111, 121, 131, 141, 151, 161 and the base plates 211, 221, 231, 241, 251, 261, 271 are explained in more detail with reference to FIGS. 17, 18 and 19.

FIG. 17 shows the L-shaped profile 131 of FIGS. 3a, 3b. As can be seen from the illustration, each of the base plates 221, 231, 241, 251, 261, 271 can be releasably fastened to the L-shaped profile 131 by having self-tapping screws 401 traverse the respective mounting boreholes 224, 234, 244, 254, 264, 274 and engage in the boreholes 136. It is to be understood that the same also applies to the other L-shaped profiles 121, 141. At the other end of the L-shaped profile 131, the clamping plate 321 is releasably fastened by having self-tapping screws traverse the mounting boreholes 324 and engage in the boreholes 136.

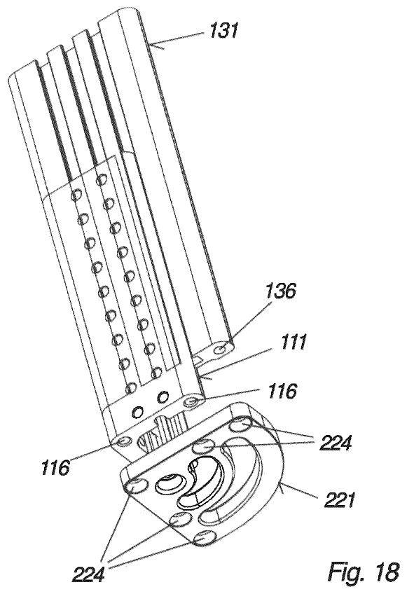

FIG. 18 shows the base plate 221 of FIGS. 8a, 8b. As can be seen from the schematic illustration, both the L-shaped profile 111 and the L-shaped profile 131 can be releasably fastened to the base plate 221 by having self-tapping screws, not shown here, traverse the respective mounting boreholes 224 and engage into the boreholes 116 or 136. It is to be understood that the same also applies to the other base plate 231 and the other L-shaped profiles 121, 141.

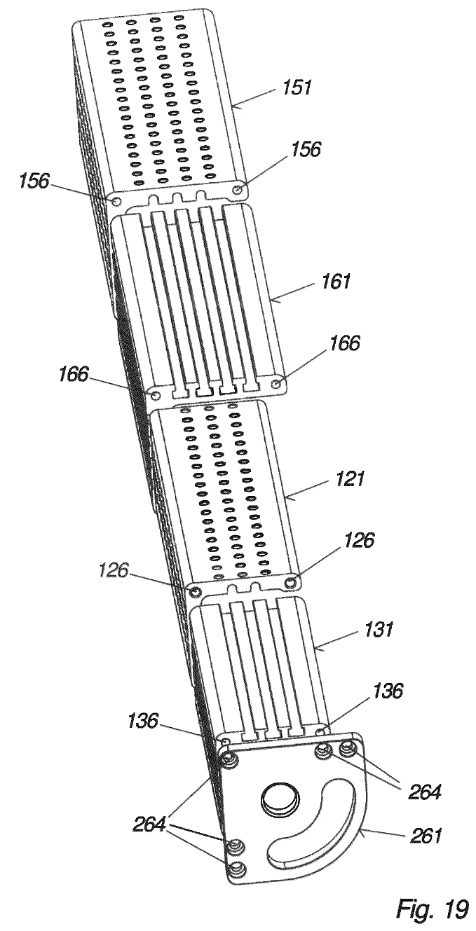

FIG. 19 shows the base plate 261 of FIGS. 12a, 12b. As can be seen from the schematic illustration, the L-shaped profiles 121, 131, 151, 161 can be releasably fastened to the base plate 261 by having self-tapping screws, not shown here, traverse the respective mounting boreholes 264 and engage into the boreholes 126, 136, 156, 166. It is to be understood that the same also applies to the other L-shaped profile 141.

FIGS. 20a, 20b, 20c depict an angle element 411, which includes an L-shaped profile 131, at one end of which a base plate 251 and at the other end of which a clamping plate 321 are releasably fastened. For this purpose, self-tapping screws 401 traverse the mounting boreholes 254 or 324 and engage into the boreholes 136. A quick-change clamp 412 is fastened to the clamping plate 321 with threaded screws 413 which engage into the threaded boreholes 322. The quick-change clamp 412 is a vertical clamp, although it is to be understood that another type of quick-change clamp, for example a horizontal clamp or a push-rod clamp, may also find application. The angle element 411 can be mounted on a welding table with quick-change clamping bolts, not shown, of a corresponding welding and clamping table system, which are inserted into the system borehole 252 and into one of the circular arc-shaped recesses 255.

FIGS. 21a, 21b depict another angle element 414, which includes an L-shaped profile 131, at each of both ends of which a base plate 231 is releasably fastened. For this purpose, self-tapping screws 401 traverse the mounting boreholes 254 and engage into the boreholes 136. Mounted on the upper base plate 231 is a screw clamp 415 by engaging a round foot piece of the screw clamp 415 in the system borehole 232. It is to be understood that other accessories of a corresponding welding and clamping table system can also be fastened to the upper base plate 231. The angle element 414 can be mounted on a welding table with quick-change clamping bolts, not shown, of a corresponding welding and clamping table system, which are inserted into the system borehole 232 of the lower base plate 231 and into the circular arc-shaped recess 235.

Of course, countless other combinations are possible within the scope of the modular system according to the invention. The angle elements can hereby be individually adjusted by sawing the L-shaped profiles to the right height and by selecting the stability characteristic that corresponds to the load demands. The usability of the base plates for several L-shaped profiles offers a high level of flexibility. The angle elements are hereby compatible with the various designs of welding and clamping table systems. Both L-shaped profile blanks that are no longer needed and the base plates and clamping plates can be reused for new angle elements.

### LIST OF REFERENCE SIGNS

111 L-shaped profile
112 leg
113 length of 112
114 thickness of 112
115 face ends
116 boreholes
117 threaded boreholes
121 L-shaped profile
122 leg
123 length of 122
124 thickness of 122
125 face ends
126 boreholes
127 threaded boreholes
131 L-shaped profile
132 leg
133 length of 132
134 thickness of 132
135 face ends
136 boreholes
138 T-slots
141 L-shaped profile
142 leg
143 length of 132
144 thickness of 132
145 face ends
146 threaded boreholes
147 T-slots
151 L-shaped profile
152 leg
153 length of 122
154 thickness of 122
155 face ends
156 boreholes
157 threaded boreholes
161 L-shaped profile
162 leg
163 length of 132
164 thickness of 132
165 face ends
166 boreholes
168 T-slots
211 base plate
212 system borehole
213 dimensions
214 mounting boreholes
215 circular arc-shaped recess
221 base plate
222 system borehole
223 dimensions
224 mounting boreholes
225 circular arc-shaped recess
231 base plate
232 system borehole
233 dimensions
234 mounting boreholes
235 circular arc-shaped recess
241 base plate
242 system borehole
243 dimensions
244 mounting boreholes
245 circular arc-shaped recess
251 base plate
252 system borehole
253 dimensions
254 mounting boreholes
255 circular arc-shaped recess
261 base plate
262 system borehole
263 dimensions
264 mounting boreholes
265 circular arc-shaped recess
271 base plate
272 system borehole
273 dimensions
274 mounting boreholes
275 circular arc-shaped recess
311 clamping plate
312 threaded boreholes
313 dimensions
314 mounting boreholes
321 clamping plate
322 threaded boreholes
323 dimensions
324 mounting boreholes
331 clamping plate
332 threaded boreholes
333 dimensions
334 mounting boreholes
401 self-tapping screws
411 angle element
412 quick-change clamp
413 threaded screws
414 angle element
415 screw clamp

1.-9. (canceled)

10. An angle element for a welding and clamping table system, said angle element comprising:
an L-shaped profile;
a base plate releasably fastened at one end of the L-shaped profile and provided with a system borehole of the welding and clamping table system; and
a member releasably fastened at another end of the L-shaped profile and selected from the group consisting of a further said base plate and a clamping plate which is provided with several threaded boreholes to accommodate various hole patterns of quick-change clamps.

11. The angle element of claim 10, wherein at least one of the base plate and the clamping plate has mounting boreholes which coincide with corresponding boreholes in face ends of the L-shaped profile, and further comprising self-tapping screws fastening the at least one of the base plate and the clamping plate on the L-shaped profile via the mounting boreholes.

12. The angle element of claim 10, wherein the base plate includes a circular arc-shaped recess.

13. The angle element of claim 10, wherein L-shaped profile includes legs having outer sides which are provided with T-slots and/or with threaded boreholes.

14. A modular system for producing various variants of an angle element, said modular system comprising:
a plurality of L-shaped profiles in different stability characteristics;
a plurality of base plates with different system boreholes for different welding and clamping table systems and/or with different dimensions corresponding to the stability characteristics of the L-shaped profiles;
a plurality of clamping plates with different dimensions corresponding to the stability characteristics of the L-shaped profiles;

15. The modular system claim 14, wherein the L-shaped profiles are provided in a standardized length and capable of being shortened individually.

16. The modular system claim 14, wherein each of the L-shaped profiles has legs having outer sides provided with T-slots and/or threaded boreholes.

17. The modular system claim 14, wherein the base plates and/or the clamping plates have mounting boreholes which coincide with corresponding boreholes in face ends of at least one of the L-shaped profiles, and further comprising self-tapping screws for fastening the base plates and/or the clamping plates to the at least one of L-shaped profiles.

18. The modular system claim 14, wherein the base plates include a circular arc-shaped recess for different welding and clamping table systems.
